(19) United States
(12) Patent Application Publication
(10) Pub. No.: US 2019/0205938 A1
(43) Pub. Date: Jul. 4, 2019

(54) DYNAMIC PRODUCT PLACEMENT BASED ON PERCEIVED VALUE

(71) Applicant: eBay Inc., San Jose, CA (US)

(72) Inventors: Justin Van WINKLE, Los Gatos, CA (US); David RAMADGE, San Jose, CA (US); Corinne Elizabeth SHERMAN, San Jose, CA (US); Dane Glasgow, Los Altos, CA (US)

(21) Appl. No.: 14/588,332

(22) Filed: Dec. 31, 2014

(51) Int. Cl. G06Q 30/02; G11B 27/034; H04N 21/234; H04N 21/442; H04N 21/458; H04N 21/81

(52) U.S. Cl. CPC G06Q 30/0269; G06Q 30/0201; G06Q 30/0255; G06Q 30/0273; H04N 21/812; H04N 21/23424; H04N 21/44222; H04N 21/458; G11B 27/034

(57) ABSTRACT

Systems and methods determine a user's perceived value of a good or service (“product”) and store the perceived value in a perception map. A perceived value may be measured by asking questions regarding a value of a product alone or in relation to another product. The perception map may be used for product placement by dynamically placing a product based on a user's perceived value of a product, generate purchase recommendations, generate exchange recommendations, and generate return value recommendations.

### CROSS-REFERENCE TO RELATED APPLICATION

This application is being filed concurrently with U.S. patent application Ser. No. 14/588,344, filed on Dec. 31, 2014 and entitled “Product Recommendation Based On Perceived Value,” which is incorporated herein by reference in its entirety.

### FIELD OF THE DISCLOSURE

The present disclosure relates to a method and system for determining perceived value. More specifically, it relates to determining perceived value of a good or service and using the determination to make purchase and/or exchange recommendations and to dynamically place a good or service in multimedia.

### BACKGROUND

Consumer attitudes and decision making may be based on a perceived value of a product. Perceived value can be difficult to measure. For example, consumers may have varied definitions for what constitutes value: price, product features, product quality, etc. There exists a need in the art to accurately determine perceived value and leverage the understanding of perceived value in marketing activities. There also exists a need in the art to recommend products for purchase and/or exchange based on perceived values.

Strategic use of product placement in audiovisual media (multimedia) can increase product awareness, enhance product perception, and increase sales. The efficacy of product placement may depend, in part, on the susceptibility of an audience, e.g., a perception of product value. Thus, there exists a need in the art for a method of product placement which takes advantage of a viewer's perceived value of the product.

### BRIEF DESCRIPTION OF THE DRAWINGS

FIG. 1 is a simplified block diagram of a system.

FIG. 2 is a simplified block diagram of a device according to an embodiment.

FIG. 3 is a flowchart of a method for determining user perception according to an embodiment.

FIG. 4A is a flowchart of a method for generating questions to determine user perception according to an embodiment.

FIG. 4B is a flowchart of a method for generating questions to determine user perception according to an embodiment.

FIG. 4C is a flowchart of a method for generating questions to determine user perception according to an embodiment.

FIG. 5A is an exemplary perceptual map according to an embodiment.

FIG. 5B is an exemplary perceptual map according to an embodiment.

FIG. 5C is an exemplary perceptual map according to an embodiment.

FIG. 5D is an exemplary perceptual map according to an embodiment.

FIG. 6A is a flowchart of a method for product placement according to an embodiment.

FIG. 6B is a flowchart of a method for product placement according to an embodiment.

FIG. 7 is a flowchart of a method for product placement according to an embodiment.

FIG. 8A is an exemplary diagram of a product placement composition according to an embodiment.

FIG. 8B is an exemplary diagram of a product placement composition according to an embodiment.

FIG. 8C is an exemplary diagram of a product placement composition according to an embodiment.

FIG. 9 is a flowchart of a method for product placement based on user perception according to an embodiment.

FIG. 10A is a flowchart of a method for recommending a product based on user perception according to an embodiment.

FIG. 10B is a flowchart of a method 950 for recommending a product based on user perception according to an embodiment.

FIG. 11 is a flowchart of a method for recommending a product for exchange based on user perception according to an embodiment.

FIG. 12 is a flowchart of a method for increasing return value of a product based on user perception according to an embodiment.

### DETAILED DESCRIPTION

In an embodiment, a method incorporates an image of a product into template video data. The method may include determining a perceived value, i.e. a user's perception of a product represented by a product image. If the perceived value is above a threshold, the method may generate a frame of video data containing the product image incorporated into the frame of template video data. The method may render the generated frame of video data.

In another embodiment, a method advertises a product by monitoring user reaction to and/or interaction with the product. The method may also assess a user's perception of the product by weighting the user's reaction(s) and/or interaction(s). The method may place the product within multimedia by replacing a generic version of the product with the product, render the multimedia, and assess a fee for rendering the multimedia.

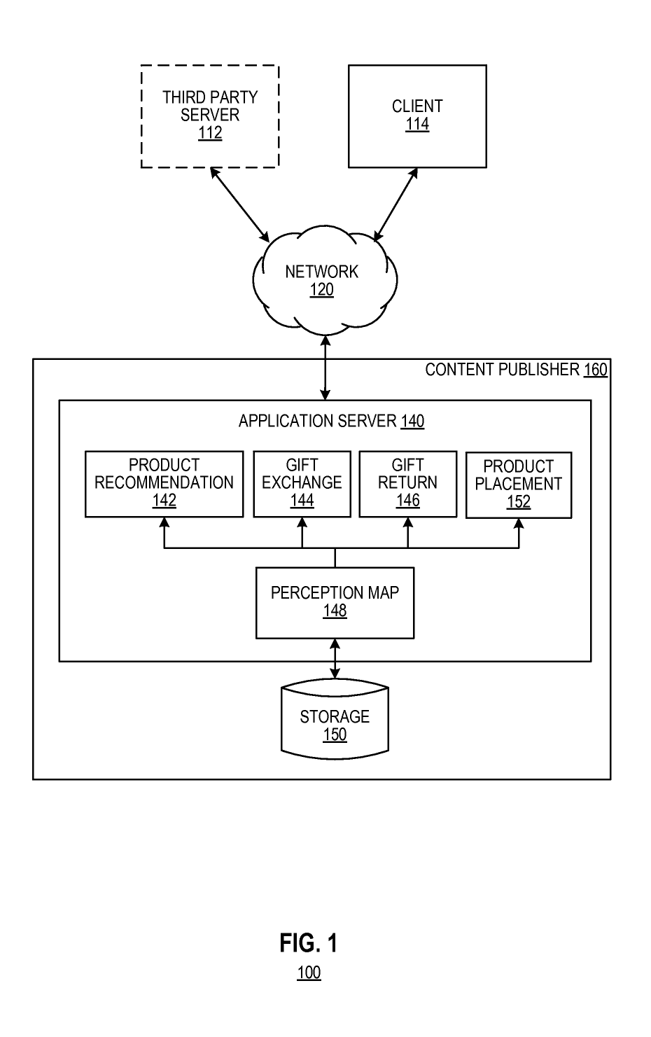

FIG. 1 is a simplified block diagram of a system 100 implementing the methods and systems described herein. The system 100 includes a content publisher 160, a client 114, and, optionally, a third party server 112. Each element of the system 100 may exchange data via a network 120. The content publisher 160 may publish content gathered, generated, or derived from the elements of the system. The client 114 may represent a user or be controlled by a user to provide data to and receive data from the content publisher 160.

The content publisher 160 may include an application server 140 and storage 150. The content publisher 160 may include a data exchange platform such as a virtual marketplace. The virtual machine may host transactions such as purchasing and selling goods and services including auctions. The data exchange platform may also host processes assisting the transactions such as generating recommendations, synchronizing financial journals, distribution of goods, collection, and payment. The application server 140 may include a perception map machine 148, a product recommendation machine 142, a gift exchange machine 144, a gift return machine 146, and a product placement machine 152. The application server 140 may be communicatively coupled to storage 150.

The network 120 may include any wired connection, wireless connection, or combination thereof, a non-exhaustive list including: LAN (local area network), WAN (wide area network), VPN (virtual private network), cellular network, satellite network, Wi-Fi network, optical network, the Internet, and a Cloud network. The network 120 may use any combination of transmission protocols or techniques.

Storage 150 may include any permanent memory circuit, temporary memory circuit, or combination thereof, a non-exhaustive list including: ROM (read-only memory), RAM (random access memory), EEPROM (electrically erasable programmable read-only memory), Flash memory, CD (compact disk), DVD (digital versatile disk), hard disk drive, or solid state drive.

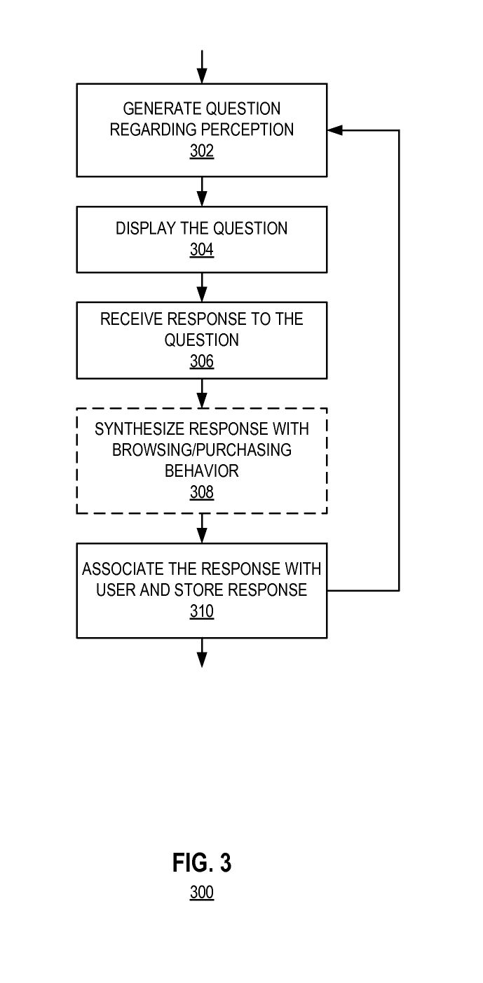

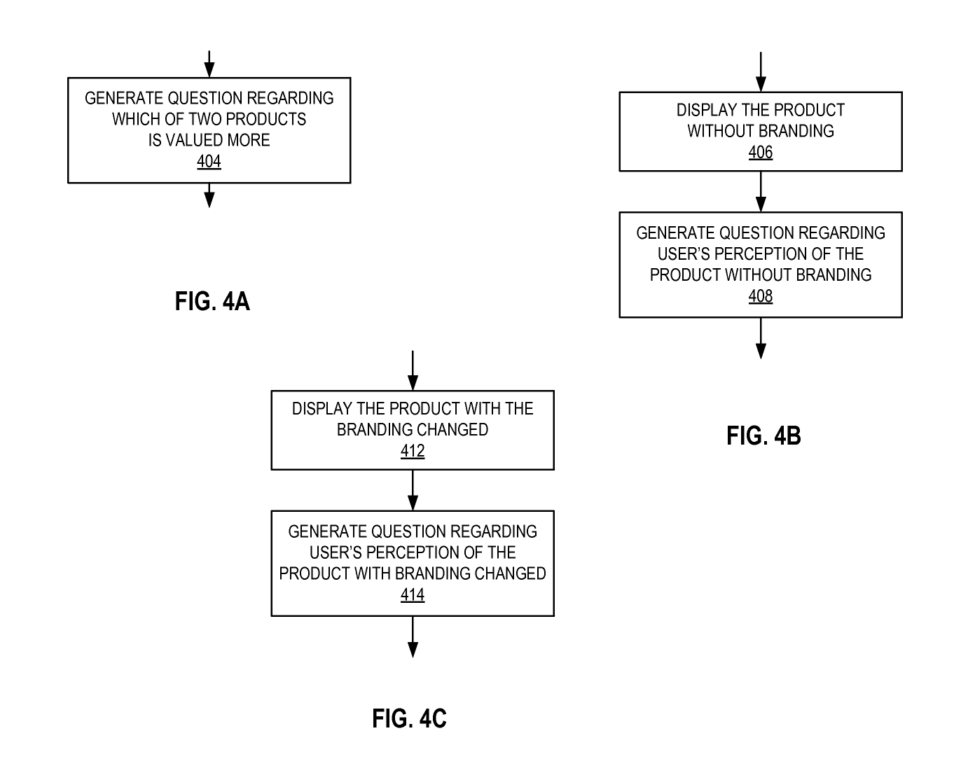

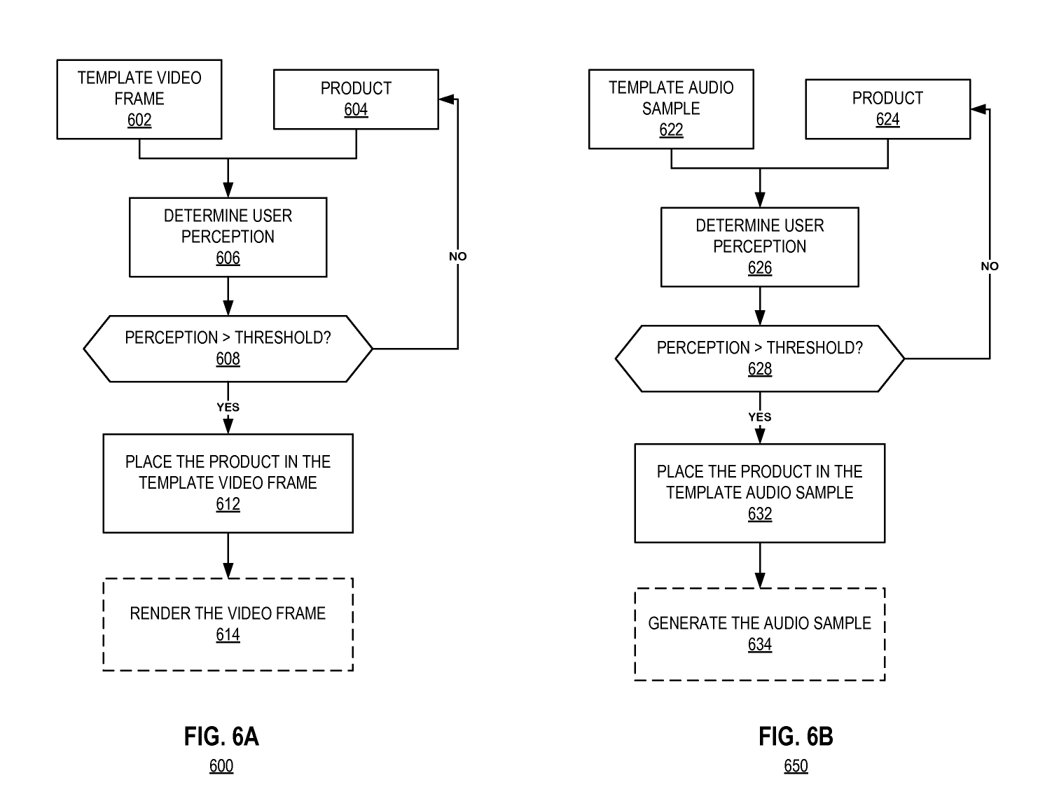

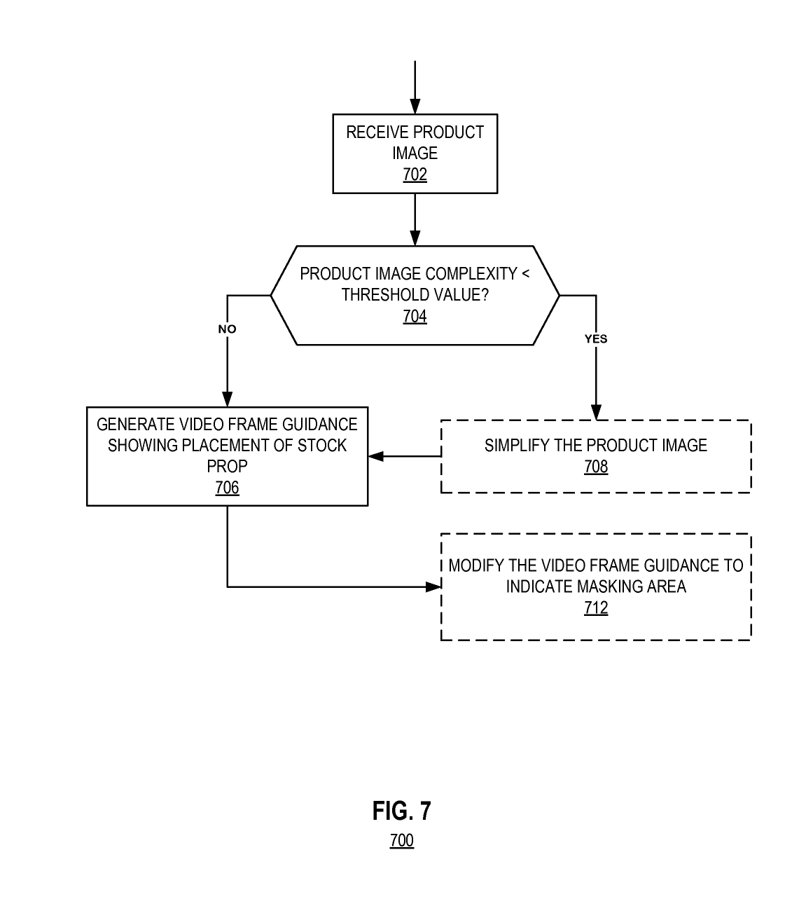

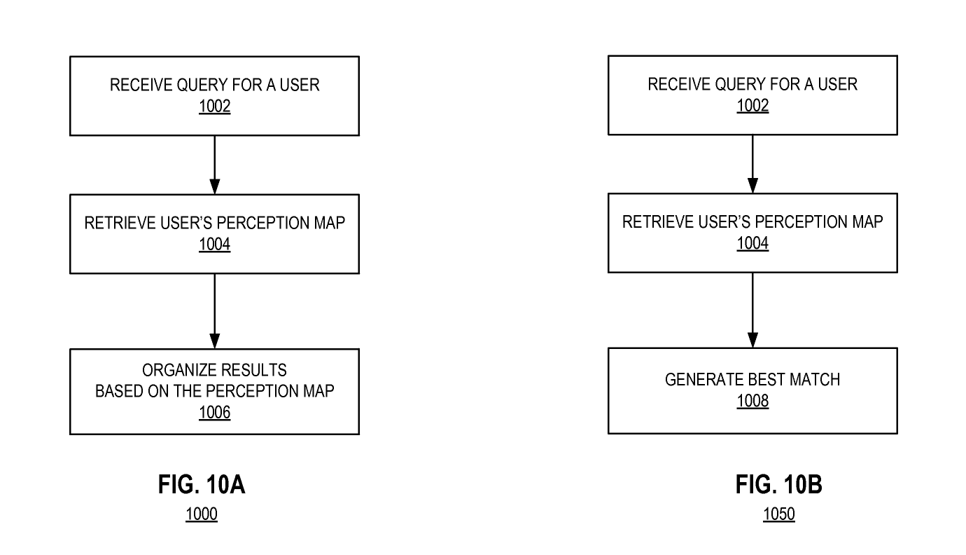

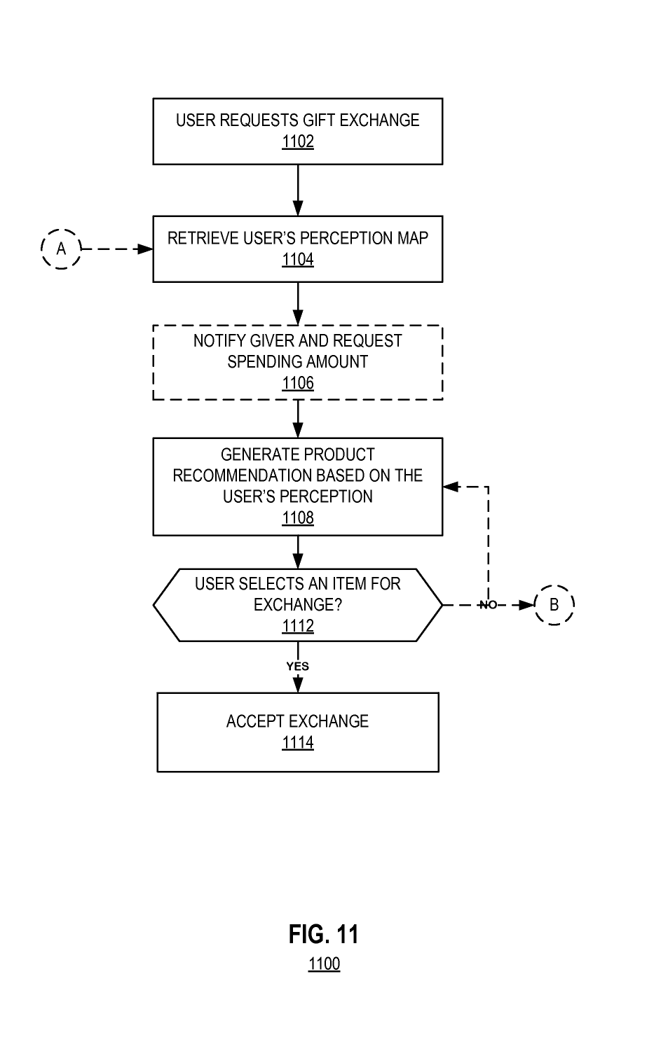

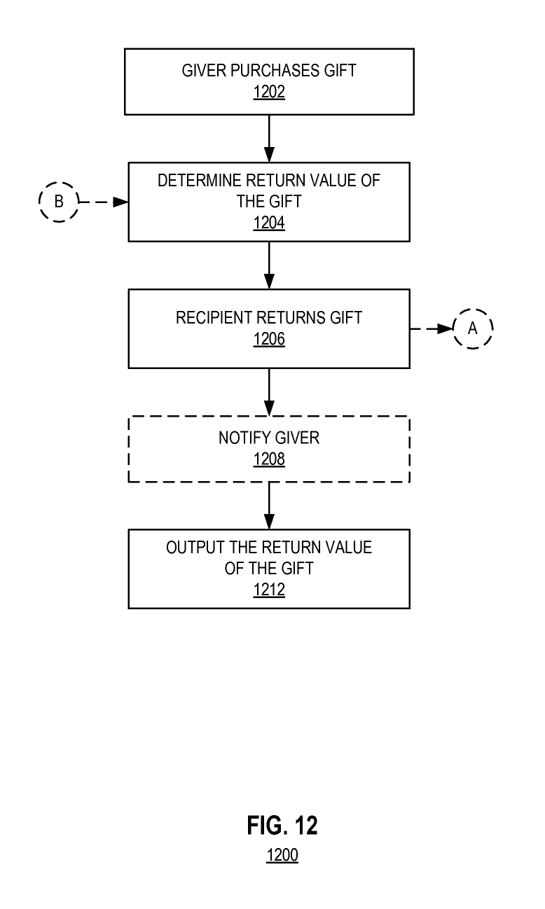

Each of the perception map machine 148, the product recommendation machine 142, the gift exchange machine 144, the gift return machine 146, and the product placement machine 152 may be operated according to the methods described herein. For example, the perception map machine 148 may perform the methods shown in FIGS. 3 and 4, the product recommendation machine 142 may perform the methods shown in FIGS. 10A and 10B, the gift exchange machine 144 may perform the method shown in FIG. 11, the gift return machine 146 may perform the method shown in FIG. 12, and the product placement machine 152 may perform the methods shown in FIGS. 6A, 6B, and 7.

The system 100 is an illustrative system having a client-server architecture. The system may be embodied in other types of architectures, including, but not limited to peer-to-peer network environments and distributed network environments.

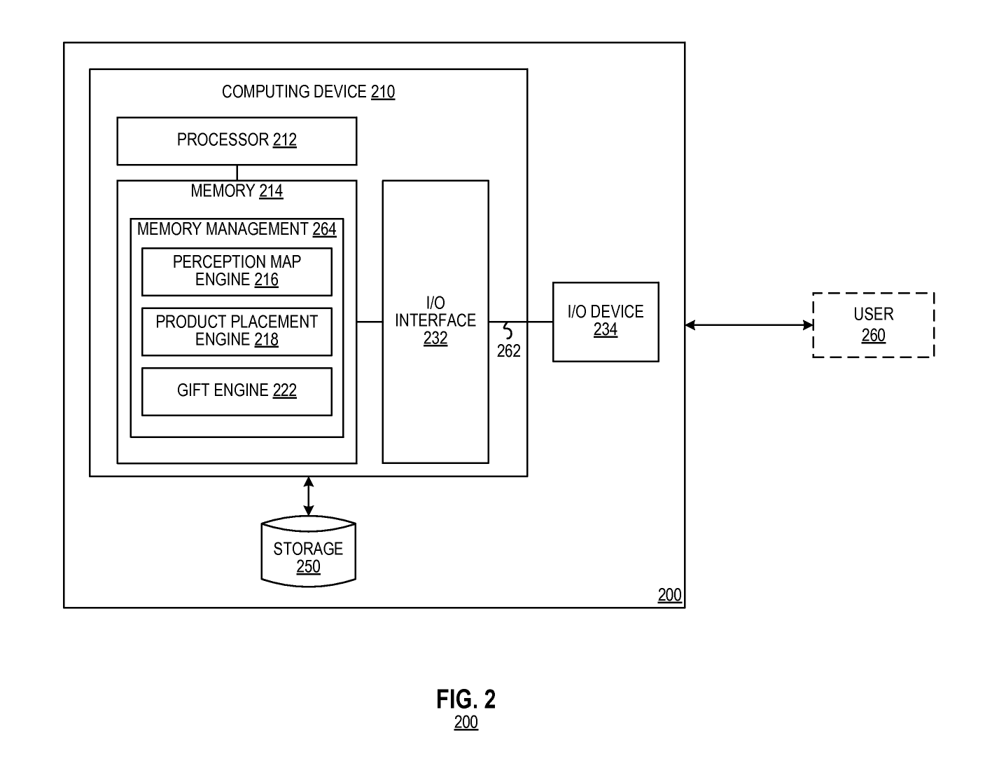

FIG. 2 is a simplified block diagram of a device 200 for implementing the methods and systems described herein. The device may be a server system or a client system. The device may include a computing device 210, an I/O (input/output) device 234, and storage 250. The computing device may include a processor 212, memory 214, and an I/O interface 232. Each of the components may be connected via a bus 262.

The processor 212 executes computer program code, for example code stored in memory 214 or storage 250. The execution of the code may include reading and/or writing to/from memory 214, storage 250, and/or I/O device 234. The program code may execute the methods described herein.

Memory 214 may include, or otherwise may communicate with a memory management system 264. The memory management system 264 may include a perception map engine 216, a product placement engine 218, and a gift engine 222. The perception map engine 216 may be configured to make computing device 210 operable to monitor reactions and interactions by a user 260 with the device 200 or sent to the device 200, for example via a network. The perception map engine may implement the methods described herein, e.g., in relation to FIGS. 3, 4A, and 4B.

The product placement engine 218 may be configured to make computing device 210 operable to place products within multimedia content. The product placement engine may implement the methods described herein, e.g., in relation to FIGS. 6A, 6B, and 7.

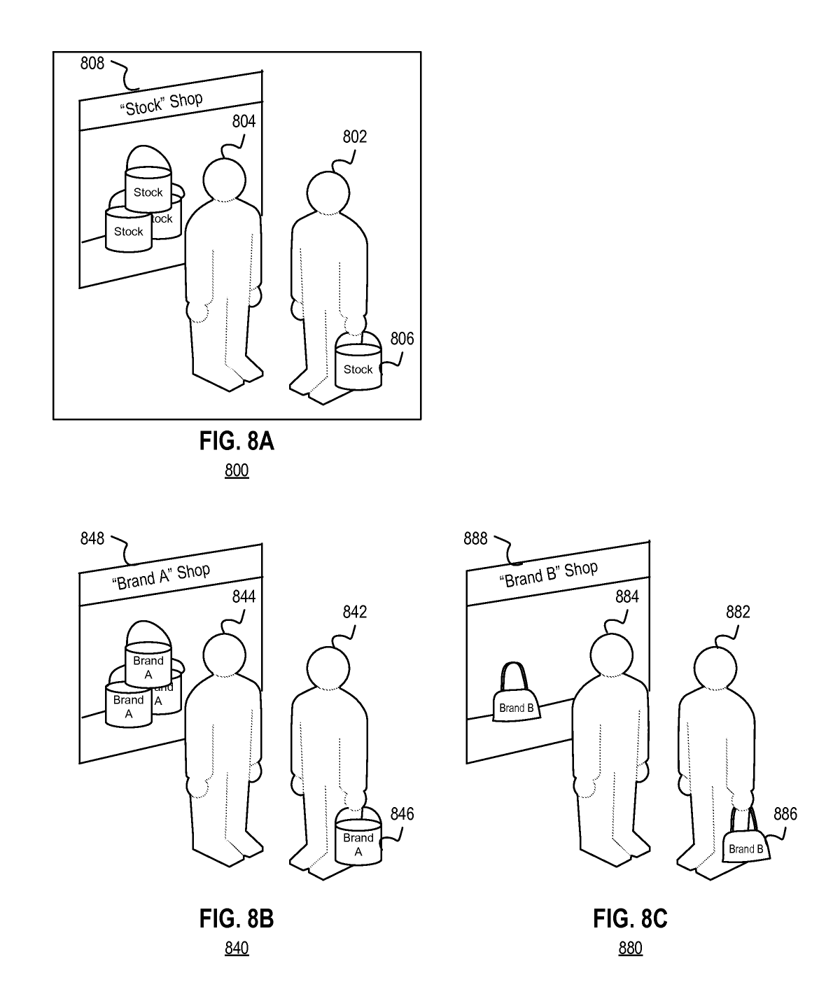

The gift engine 222 may be configured to make computing device 210 operable to make purchasing recommendations and exchange recommendations. The gift engine may implement the methods described herein, e.g., in relation to FIGS. 8-12.

One of ordinary skill in the art would understand that a different number of engines than the ones shown may be included in, or otherwise may communicate with memory 214. The functionality described for each engine may also be apportioned to different engines. Additional engines are also possible. For example, a billing engine may be configured to charge a vendor for at least some of the information stored in storage 250 or memory 214. The billing engine may be further configured to charge vendors for product placement or display of products at a particular time and/or location. For example, the billing engine may charge a vendor for incorporating a product into a television show. As another example, the billing engine may charge a vendor for displaying a product within a list of search results.

Memory 214 may include local memory usable during execution of program code, cache memory temporarily storing program code, and bulk storage. The local memory may include any permanent memory circuit, temporary memory circuit, or combination thereof, a non-exhaustive list including: ROM, RAM, EEPROM, and Flash memory.

The I/O device 234 may include any device enabling a user to interact with the computing device 210, including but not limited to a keyboard, pointing device such as a mouse, touchscreen, microphone, speaker system, computer display, and printer.

The computing device 210 may include any special purpose and/or general purpose computing article of manufacture executing computer program code, including, but not limited to, a personal computer, a smart device such as a smartphone, and a server. The computing device may be a combination of general and/or specific purpose hardware and/or program code.

The device 200 may be embodied as a single server or a cluster of servers including at least two servers communicating over any type of communications link. A communications link may include any wired connection, wireless connection, or combination thereof, a non-exhaustive list including: LAN (local area network), WAN (wide area network), VPN (virtual private network), cellular network, satellite network, Wi-Fi network, optical network, the Internet, and a Cloud network. The communications link may use any combination of transmission protocols or techniques.

Consumers may perceive a value or have a taste for a particular good. For example, a consumer may perceive that a particular brand is valuable. Brand perception can be related to or independent of a style or form factor of a product. For some consumers, a perceived value of a good may influence whether the consumer makes a purchase or a return. The perceived value may also be weighed against the price at which a good is offered for sale in making a purchasing decision. Thus, there exists a need in the art to determine the perceived value of a good.

The operations of FIGS. 3-12 may be implemented and executed from either a server or a client (either of which may be generally represented in FIG. 2).

User perception may be described and stored in a “map” of perceptions. A map of perceptions (“perception map” for simplicity) refers to a profile of attributes that may be used to predict purchasing behavior. For example, attributes may include a user's tastes, views, values, and habits. The perception map may include a single attribute, or many attributes. The perception map may store a relationship among product purchasing factors, such as product cost and product quality. The perception map or analytics derived from the map may be sold or licensed as described herein.

In another embodiment, the perception map may be used to select products for development. For example, popularity, i.e., high perceived value, of a product may indicate that additional products in a family of products related to the product may also be popular. As another example, an indication that a brand for a product is generally unimportant may suggest that the product is a good candidate for producing a generic version because consumers would likely make a purchasing decision with little or no regard for the brand of the product. The importance of a brand to a purchasing decision may be measured by a perceived value in relation to a threshold value.

The embodiments herein may refer to a good, product, or service. One of ordinary skill in the art would understand that the principles described herein apply analogously to a good, a product, or service.

FIG. 3 is a flowchart of an exemplary method 300 for determining user perception(s). In box 302, the method 300 generates a question regarding a perception of a product such as price or inclination to purchase the product. The question may be displayed in box 304. In an embodiment, the display of the question may include displaying the text of the question. In another embodiment, the display of the question may include presenting an image of the good followed by the question. In box 306, the method 300 may receive a response to the displayed question. The response may be associated with a user who is providing the answers to the questions (box 310). The response may be stored, for example in association with a user profile.

In box 302, the question may be of various forms. For example, the question may ask a user to guess the price of the product. As another example, the question may ask a user whether the user would buy the product at a pre-definable price. As yet another example, a question may present a product with a price and asking the user whether the price offered is too high or too low. Further examples of questions are shown in FIGS. 4A, 4B, and 4C. Box 302 may be replaced by the boxes shown in each of FIGS. 4A, 4B, and 4C. The question may be generated from a pool, list, etc. of products. For example, the product about which a question is asked may be a product that is popular with a group of users, such as all users of an application implementing method 300, or a subset of users, such as those who are part of a demographic. As another example, the product may be one designated by a vendor interested in gauging user perception of the product. As yet another example, the product may be based on a user's browsing history, e.g. Internet browsing history, which may reflect a user's interest in a product at a particular time. For example, the browsing history may include a length of time a user spends on a website, a user's interaction with a website element, a user's reaction to a website element, and/or a user's exposure to a website element. The browsing history may indicate that a user attaches some value to a product and/or a product category. For example, a user's exposure to a website element may include whether an advertisement for a product is displayed on a website that the user is browsing. The advertisement may be displayed as a result of targeted advertising, which may indicate the user's interests.

The method 300 may be a part of another process. For example, a user may be logged into or engaging with a virtual environment prior to commencement of method 300. The method 300 may find application in a user-interactive questionnaire or game such as a snacking game. A snacking game may be a game designed with questions that elicit responses after a short period such as 10 to 60 seconds. For example, questions may be generated according to the steps of method 300 in a web application such as a smartphone or tablet application. In an embodiment, the game may be an auctioning game or include features resembling an auctioning process in which a user bids for a product. The bidding may indicate a perceived value by determining a minimum and maximum price the user is willing to pay for the product.

FIGS. 4A, 4B, and 4C each shows an exemplary method for generating a question to determine user perception. The steps for each method may be performed as part of another method such as method 300. For example, two goods may be presented and a user may be asked which one is worth more (box 404). The question may be phrased with respect to a product's value, worth, etc. For example, a consumer's attitude may be gauged at different price points by asking questions such as “Is this a good deal?,” “Is this over-priced?,” “Is this probably a counterfeit?,” etc. In an embodiment, the question may ask a user a minimum and/or a maximum price the user is willing to pay for the product. As another example, two goods may be presented and a user may be asked for the user's estimation of the price difference between the two goods. The price difference may indicate which good the user values more. The price difference may be compared with an actual retail price or a typical sale price to determine perceived value of the good. In another embodiment, a product may be displayed without branding, for example, without showing a logo, icon, trademark, image, etc. associated with the product (box 406). The user's response may indicate a relative importance of style to brand. The user may be asked for an impression of the product without branding (box 408). Differences, if any, between responses to the same product with branding and without branding may indicate the importance of the brand to the user. In another embodiment, a product may be displayed with branding altered, for example, by altering a typeface and/or a logo associated with the product or by replacing native branding, i.e., branding found in the marketplace, on the product with branding for another manufacturer of the same or a similar product (box 412). The user may be asked for a perception of the product (box 414). Differences, if any, between responses to the same product with native branding and with altered branding may indicate the importance of the brand to the user. The user's response may indicate a relative importance of style to brand.

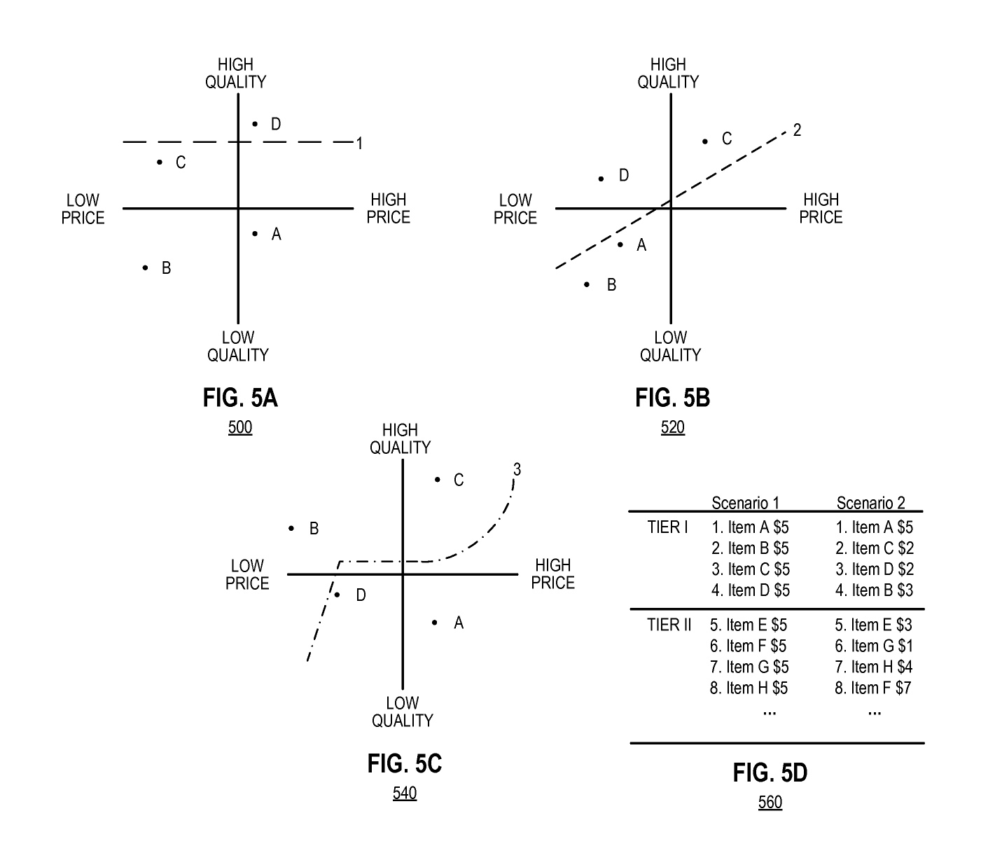

Each response may provide a data point for a perception map for the user, indicating the user's value of a particular product, service, and/or brand or a group thereof. FIGS. 5A, 5B, 5C, and 5D show exemplary perception maps 500, 520, 540, and 560. In the exemplary perceptual maps 500, 520, and 540 shown in FIGS. 5A, 5B, and 5C, user perceptions are represented in terms of quality, shown on the y-axis, and price, shown on the x-axis. A price associated with a product may be based on a retail price or difference in pricing, e.g., regional differences, discounts provided to loyalty members, etc. One of ordinary skill in the art would understand that other attributes may be represented in the perceptual map. For example, rather than price and quality, the x-axis and y-axis may respectively represent other attributes.

From the perspective of a user, a particular product may have an associated price and quality, represented as a coordinate on the perceptual map 500 in FIG. 5A. For example, A represents on one product, D represents another product, C represents yet another product, etc. The likelihood of a user buying a product may be related to the user's perception of a product's quality and price. A user is not expected buy a product if the user's perception of the product's quality and price falls below the curve. The coordinates for each of the values for the products, A, B, C, and D, may be determined according to the methods discussed herein.

In the example of User 1 shown in perceptual map 500, User 1 is not expected to purchase a product below a certain level of quality regardless of price. That is, User 1 will not purchase a product having a quality below the level of the dashed line. For the products shown in perceptual map 500, User 1 is not expected to purchase products A, B, or C. User 1 is expected to purchase product D.

In the example of User 2 shown in perception map 520 in FIG. 5B, User 2 will not purchase a product having a quality below the level of the dashed line. For the products shown in perceptual map 520, User 2 is not expected to purchase products A or B. User 2 is expected to purchase products C or D.

More complex user perception profiles are possible. For example, in the example of User 3 shown in perceptual map 540 in FIG. 5C, User 3 will not purchase a product having a quality below the level of the dashed line. For the products shown in perceptual map 540, User 3 is not expected to purchase products A or D. User 3 is expected to purchase product B or C. User 3 may treat a category of high price, high quality “luxury goods” (represented as the quadratic segment of the curve) having high quality and high price differently from those goods that are below a particular price.

Each point on the perceptual map represents a particular user's perception of a particular product. Perceptions may vary from user to user. This is illustrated by the differing perceptions of Users 1, 2, and 3 in the perceptual maps 500, 520, and 540. For example, product A is in the lower right quadrant for Users 1 and 3, and in the lower left quadrant for User 2. FIG. 5D represents perceptions of a user in different scenarios. Each Item A-H may represent a different product. In each scenario, a product may be ranked according to a likelihood that the user would purchase the respective product for a given attribute. For example, in Scenario 1, all of the products have the same attribute: price ($5). In that scenario, the user would prefer to purchase Item A over Item B, Item B over Item C, etc. In Scenario 2, the products do not all have the same price. For example, scenario 2 illustrates the relative unimportance of price to the user. For example, the user prefers Item A ($5) over Item C, which has a lower price ($2). The user's preference may be due to brand loyalty or other perceptions of attributes associated with Item A.

A user may also have product preferences based on brand preferences. A preference may be represented in a perception map in a tiered format. A user is expected to purchase a product in a higher tier over a product in a lower tier notwithstanding attributes associated with each product. In the example shown in perception map 560, the user would purchase a product in the first tier (“Tier I”) over a product in a second tier (“Tier II”). That is, the user would never purchase a product from the second tier before purchasing a product in the first tier. For example, in Scenario 2, although Item G is offered at a price ($1) lower than Item B ($3), the user would nevertheless be expected to prefer Item B. Of course, an order of products may change over time or after a purchase is made.

The examples provided above refer to a user considering purchase of a product for purely illustrative purposes. A perception map may also be applicable to other user decisions including return of a product. For example, a perception map may indicate factors in a user's interest in returning a product. As another example, a perception map may indicate that a return of a product influences a user's interest in purchasing another product.

While the foregoing discussion regarding the perceptual maps refers to a user associated with each map, one of ordinary skill in the art would understand that a map may correspond to a group of users, and that maps may be aggregated. A preference may also be represented in mathematical form. For example, once a threshold number of data points is accumulated, a curve may be fitted to the data points and associated and stored with a user to predict purchasing behavior, e.g., the user is not expected to purchase products below a curve representing attribute(s) of a product. Each of the perceptual maps 500, 520, 540, and 560 may be stored in a storage system according to conventional methods and data structures, for example in a database table accessible via SQL queries.

The perception map may find application in many processes and systems, for example, product placement, providing purchasing recommendations, providing exchange recommendations, and providing gift return value recommendations. Each of these examples is further described herein.

The efficacy of product placement in multimedia may depend, in part, on the perception of the user of the multimedia. For instance, a user who perceives a higher value of a product may be considered more susceptible to the product, i.e., likely to purchase the product. By leveraging user perception, a product may be dynamically placed in multimedia to maximize efficiency of advertising. In other words, product placement may be based on the likelihood of a particular user to purchase the product and may be dynamically adapted with the changing audience of the multimedia. One advantage of this practice is that if a user will never purchase a particular brand, that brand is not futilely advertised to the user. Alternatively, even if a user typically does not prefer a particular brand, the brand may be advertised to the user at a most opportune time, e.g., when the user prefers the brand more than the user historically has favored the brand. The dynamic adaptation of multimedia for product placement may include swapping a stock image of a product in a multimedia sample with a particular product to which a user is more susceptible.

FIG. 6A is a flowchart of a method 600 for product placement in video. Method 600 may receive a product image (box 604) and a template video frame (box 602), and incorporate the product into the template video frame. In an embodiment, the product is incorporated into the template video frame by replacing a stock image with an image of the product. In an alternative embodiment, the product is placed into the template video frame (without replacing an existing element of the template video frame). In box 606, the method 600 may determine a user perception of the product. For example, a user perception may be determined according to method 300 described herein. In an embodiment, the user perception may be retrieved from storage. The method 600 may then determine whether the user perception is above a threshold value (box 608). If the method determines in box 608 that a user perception is not above a threshold, then the method may evaluate a user perception of another product (boxes 604 and 606). A user perception below a threshold may indicate that a user is not likely to purchase the product. In an embodiment, a product that a user is likely to purchase may be placed in the template video frame in box 612. In another embodiment, a product that the user is most likely to purchase may be placed in the template video frame in box 612.

The threshold value in box 608 may be defined automatically or by a designer. For example, the threshold may be set such that a perception rating above the threshold value indicates that the user is more likely than not to purchase the product. As another example, the threshold may be set such that a perception rating corresponds to a quantifiable likelihood of a user to purchase the product.

In an embodiment, a product may be selected for placement from among several candidates based on one or more factors such as: a perception map with a ranking, such as the perception maps shown in FIGS. 5A, 5B, 5C, and 5D and vendor specifications and/or payment. Optionally, the method 600 may render the video frame (box 614), for example outputting it to a display or saving a frame for future display.

In an embodiment, method 600 may be performed by a server. For example, a product may be incorporated into the multimedia content and distributed to a client for decoding and/or streaming. In another embodiment, method 600 may be performed by a client. In this example, a client device may have a locally stored image of a product and/or a template video frame. The image of the product or the template video frame may alternatively be transmitted to the client device. Based on a user's perceptions, the method 600 may make the client device operative to place the product in the template video frame.

In an embodiment, method 600 may be performed as a pre-process. Pre-processing of an image or video include determining a set-up such as a composition for a shooting of a scene. This is represented in FIGS. 6A and 6B as a “template” frame (box 602). In an embodiment, the placement of a product into a template video frame may be based on a complexity of the stock image being replaced. For example, in method 600, boxes 612 may proceed to method 700 shown in FIG. 7. Video frame guidance may then be generated showing the composition of a scene. In an embodiment, the video frame guidance may be displayed on a graphical user interface. The video frame guidance may be used during a photo or video shoot to determine how to set up the scene. The scene set up may include the size, shape, and/or placement of chroma key (e.g., green-screen) props and/or backdrops.

In another embodiment, method 600 may be performed as a post-process. Post-processing of video may include processing an image or video frame (“template frame” for simplicity) to replace a stock product with a replacement product, the selection of the replacement product being based on user perception. In FIG. 6A, the video frame prior to replacement may be represented as a “template” frame. For example, in box 602 the template video frame may be an encoded video frame and generation of the video frame in box 612 may include decoding the video frame and placing the product within the frame.

FIG. 7 is a flowchart of a method 700 for determining composition of an image including placement of a product in the image. A composition of an image refers to the placement or arrangement of visual elements within the image. The image may be a single frame forming a part of a video sequence. In box 702, the method receives an image, such as a still or moving image of a product, for placement into a template frame. The method 700 may then determine a complexity of the product image in box 704 by determining whether the complexity of the product is below a threshold value. If the complexity of the product is below the threshold value, the method 700 may proceed to box 706 in which video frame guidance is generated showing placement of a stock prop (as discussed below with reference to FIG. 8A). A stock prop may be a generic form of product. The stock prop may have approximately the same size and form factor as a specific product. Video frame guidance may be provided in the form of scene 800 (FIG. 8A), showing a best place for positioning the stock prop. For example this may be a simulation of what the product looks like in a scene. If the complexity of the product exceeds a threshold value, the method 700 may perform optional box 708 before generating the video frame guidance (box 706). In box 708, the product image/video may be simplified from its true form factor. For example, an impression of a product may be sufficient for a user to identify and associate the product with the branded product. The simplification may be performed to better fit the branded product to the stock product. Method 700 may include optional box 712 in which video frame guidance may be modified to indicate a masking area for the stock item. For example, scene 840 (FIG. 8B) may result from a determination that the “Brand A” product has a complexity below a threshold value. As another example, scene 880 (FIG. 8C) may result from a determination that the “Brand B” product has a complexity above a threshold value.

FIG. 8A is an exemplary diagram of a scene 800 in which a product may be placed. Scene 800 is shown in a state prior to product placement. In an embodiment, scene 800 is a representation of a template video frame 602 shown in method 600. In scene 800, two figures may be positioned relative to each other (for example, the figures may be engaging in a conversation). One figure 802 is holding a product labeled “Stock.” The product may be a generic, “stock” image of a product. In scene 800, the stock image may represent a handbag. Other stock images, which may be of the same item held by the person or may be stock images of other items, may be displayed in a shop window behind the other figure 804.

FIG. 8B is an exemplary diagram of a scene 840 in which a product may be placed. In an embodiment, scene 840 is a representation of a state of a video frame subsequent to product placement in steps 612 of method 600. In scene 840, two figures may be positioned relative to each other (for example, the figures may be engaging in a conversation). One figure 842 is holding a product labeled “Brand A.” The product may be an image of a branded product. Brand A may be a replacement of a generic “stock” product such as the one shown in scene 800. Similarly, other stock images displayed in a shop window behind the other figure 844 may be replaced with branded items, which may be the same as or different from the one held by figure 842. In the embodiment illustrated in scene 640, the form factor of the stock item remains substantially unchanged. This may correspond to step 704 of method 700. Some goods may have substantially the same form factor regardless of brand. These goods are typically those with less complex shapes. For example, soda cans and facial tissue boxes have substantially the same form regardless of brand.

FIG. 8C is an exemplary diagram of a scene 880 in which a product may be placed. In an embodiment, scene 880 is a representation of a state of a video frame subsequent to product placement in steps 612 of method 600. In scene 880, two figures may be positioned relative to each other (for example, the figures may be engaging in a conversation). One figure 882 is holding a product labeled “Brand B.” The product may be an image of a branded product. Brand B may be a replacement of a generic “stock” product such as the one shown in scene 800. Similarly, other stock images displayed in a shop window behind the other figure 884 may be replaced with branded items, which may be the same as or different from the one held by figure 882. In the embodiment illustrated in scene 880, the configuration of branded goods displayed in the shop window may differ from the configuration in the shop window of template scene 800. In the embodiment illustrated in scene 880, the form factor of the branded replacement item may differ substantially from that of the stock image. This may correspond to steps 708 or 712 of method 700. Some goods may have form factors that differ from a generic form factor. These goods are typically those with more complex shapes. For example, handbag shape and size typically vary from brand to brand.

Scenes 800, 840, and 880 may each represent a still image or a video frame forming part of a movie, television show, radio broadcast, podcast, documentary, news report, or the like. The scenes 800, 840, and 880 and the figures therein may be live action, an animation, or the like. The principles of product placement in video are also applicable to product placement in other forms of multimedia such as audio.

FIG. 6B is a flowchart of a method 650 for product placement in audio. Method 650 may receive a product audio clip (box 624) and a template audio sample (box 622), and incorporate the product into the template audio sample. In an embodiment the product is incorporated into the template audio sample by replacing a stock audio clip with the product audio clip. For example the stock audio clip may be “soda” and the product audio clip may be “Coca Cola.” In an alternative embodiment, the product audio clip is placed into the template audio sample (without replacing an existing element of the template audio sample). In box 626, the method 650 may determine a user perception of the product. For example, a user perception may be determined according to method 300 described herein. In an embodiment, the user perception may be retrieved from storage. The method 650 may then determine whether the user perception is above a threshold value (box 628). If the method determines in box 628 that a user perception is not above a threshold, then the method may evaluate a user perception of another product (boxes 624 and 626). A user perception below a threshold may indicate that a user is not likely to purchase the product. In an embodiment, a product that a user is likely to purchase may be placed in the template audio sample in box 632. In another embodiment, a product that the user is most likely to purchase may be placed in the template audio sample in box 632.

The threshold value in box 628 may be defined automatically or by a designer. For example, the threshold may be set such that a perception rating above the threshold value indicates that the user is more likely than not to purchase the product. As another example, the threshold may be set such that a perception rating corresponds to a quantifiable likelihood of a user to purchase the product.

In an embodiment, a product may be selected for placement from among several candidates based on one or more factors such as: a perception map with a ranking, such as the perception maps shown in FIGS. 5A, 5B, 5C, and 5D and vendor specifications and/or payment. Optionally, the method 650 may output the audio sample or save the audio sample for further projection (box 634).

In an embodiment, method 650 may be performed by a server. For example, a product may be incorporated into the multimedia content and distributed to a client for decoding and/or streaming. In another embodiment, method 650 may be performed by a client. In this example, a client device may have a locally stored audio clip of a product and/or a template audio sample. The audio clip or the template audio sample may alternatively be transmitted to the client device. Based on a user's perceptions, the method 650 may make the client device operative to place the product in the template audio sample.

In an embodiment, method 650 may be performed as a pre-process. Pre-processing of audio may include determining a set-up for narration for an audio sample. This is represented in FIG. 6B as a “template” audio sample (box 622). Audio sample guidance may then be generated showing a set-up of a narration. In an embodiment, the audio sample guidance may be displayed on a graphical user interface. The audio sample guidance may be used during a recording session to determine how to set up the narration. The narration set up may include a speed of narration, any pauses, length of pauses, etc.

In another embodiment, method 650 may be performed as a post-process. Post-processing of audio may include processing an audio sample (“template audio sample” for simplicity) to replace a stock product with a replacement product, the selection of the replacement product being based on user perception. In FIG. 6A, the audio sample prior to replacement may be represented as a “template” frame. For example, in box 622 the template audio sample may be an encoded audio sample and generation of the audio sample in box 634 may include decoding the audio sample and placing the product within the audio sample.

In an embodiment, a business method performs the steps for the methods described herein on a fee, advertising, and/or subscription basis. A service provider, for example via the content publisher 160 shown in FIG. 1, may offer to perform the steps described herein. The service provider may create, deploy, and maintain a computing infrastructure to perform the steps described herein for a customer. The service provider may receive remuneration from the customer under an agreement such as a fee or subscription agreement. The service provider may also receive payment from sale of advertising content and user information to a third party.

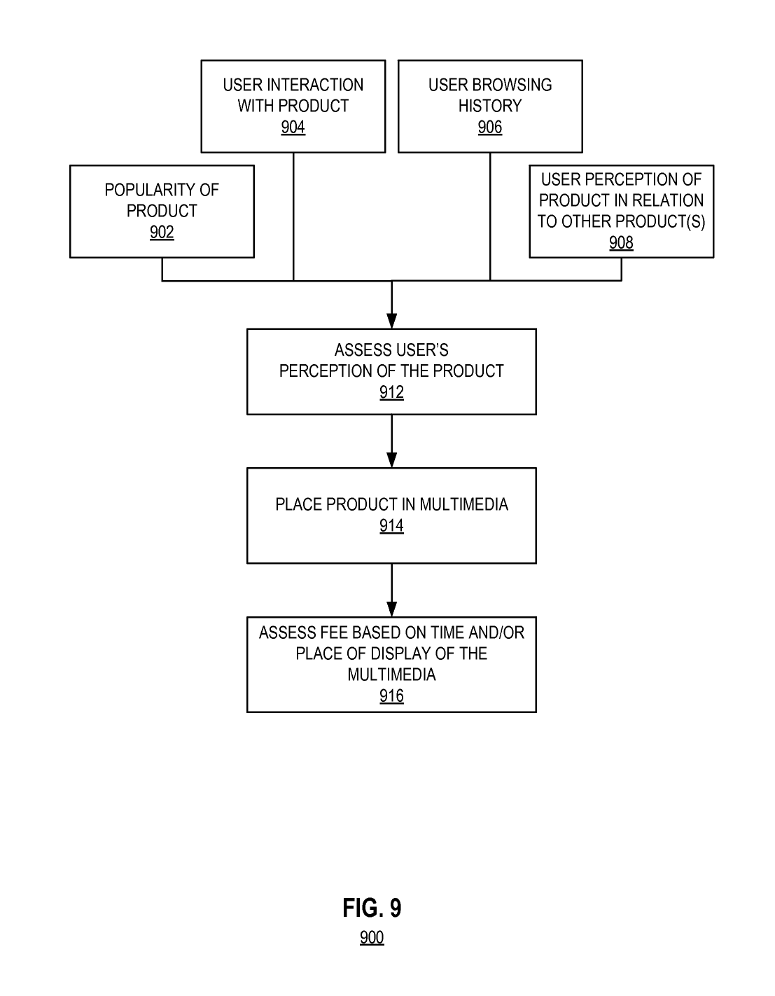

FIG. 9 is a flowchart of a method 900 for advertising a product via product placement based on user perception. In box 912, the method 900 may assess a user's perception of the product based on factors such as a popularity of a product 902, user interaction with a product 904, user browsing history 906, and a user's perception of a product relative to another product 908. The factors 902, 904, 906, and 908 may be gathered by a perception map machine such as the perception map engine 148 shown in FIG. 1. The assessment may include weighting factors such as the factors 902, 904, 906, and 908. The assessment may include ranking a user's perception of the product relative to the user's perception of other products. The ranking may be a basis for determining a likelihood that a user will purchase a product. In box 914, the method 900 may place the product in multimedia, such as a movie, a television show, a radio broadcast, a podcast, a documentary, a news report, and the like. In an embodiment, once a product has been placed in multimedia, the method 900 may assess a fee to a product vendor and/or a multimedia producer. The placement may include any combination of the following: rendering the multimedia incorporating the product, playing the multimedia incorporating the product, distributing the multimedia incorporating the product to a third party, etc.

In an embodiment, the amount of fee assessed may depend on any combination of the following: the type of multimedia into which the product is incorporated, when the multimedia is distributed to an audience, a temporal location in the multimedia where the product is placed, a spatial location in the multimedia where the product is placed, etc. For example, a product placed in the beginning or end of a multimedia stream may incur a higher fee than a product placed somewhere in the middle of the multimedia stream based on the reasoning that more viewers are likely to pay attention in the beginning or end of a multimedia stream. As another example, a product placed in a less prominent location within a scene such as a shop window of may incur a lower fee than a product placed in a more prominent location within the scene such as a handbag held by a title character of a film. In an alternative embodiment, a flat fee is assessed for placing a product anywhere in the multimedia. The fee assessment may be performed by a device such as the application server 140 shown in FIG. 1. A portion of the fee may be assessed for analyzing and providing information regarding user perception. A fee may be assessed for changing product placements.

A perception map, developed for example according to method 300, may also be used to provide purchasing recommendations. For example, when making a purchase (“gift”) for another person (“recipient” for simplicity), the purchaser (“giver” for simplicity) may not be well-acquainted with the tastes and values of the recipient. A perception map can be used in the giver's search for a gift to recommend goods that the recipient value and thus would be happy to receive.

FIG. 10A is a flowchart of a method 1000 for recommending a product based on user perception. In box 1002, the method may receive a query for a recipient. For example, the query may be a search for a gift for a recipient. The method may then retrieve the recipient's perception map. The perception map may reflect the recipient's perception of at least one product and may be constructed according to method 300. In an embodiment, the method 1000 may organize search results based on the perception map (box 1006) and any guidelines specified in the query. For example, the search results may be organized based on the recipient's perceived value of a product. The results may include products that each have perceived value above a threshold value. For example, a perception map (such as the one shown in 560) may include a list of products ranked from the most valued by the recipient to the least valued by the recipient. The results may include a subset of products, e.g., the first five, 10, 20, etc. The results may be filtered. For example, the filtering may remove those products that the user already owns so that a duplicative gift is not purchased. As another example, the filtering may be filtering within the results to refine the results.

FIG. 10B is a flowchart of a method 1050 for recommending a product based on user perception. In box 1002, the method may receive a query for a recipient. For example, the query may be a search for a gift for a recipient. The method may then retrieve the recipient's perception map. The perception map may reflect the recipient's perception of at least one product and may be constructed according to method 300. In an embodiment, a best match may be generated and displayed (box 1008). For example, the best match may be a product that the user most values. For example, a perception map (such as the one shown in 560) may include a list of products ranked from the most valued by the recipient to the least valued by the recipient, and the most valued product meeting the guidelines of the query may be selected as the best match.

The query received in box 1002 may include a product type, a price range, a specific recipient, or a group of recipients, an amount that the gift giver wishes to spend, etc. The results (box 1006) may be adjusted such that the recommended products meet specifiable guidelines. For example, all of the displayed results may be products that are priced below the amount the gift giver wishes to spend.

A perception map, for example developed according to method 300, may be used to provide exchange recommendations. For example, when a recipient returns an item that was gifted, the exchange platform may surface personalized recommendation(s) for the recipient with the same or similar perceived value as the item. The gift giver may thus be credited with giving a higher value gift, the recipient receives a desirable item in exchange, and the exchange platform facilitates clearing of an item with a higher retail value but is on markdown. For example, a giver may purchase a gift at a discount from a full retail price. When the recipient returns the gift, recommendations may be provided that have a comparable perceived value to the perceived value of the gift. A perception map of perceived values can be used to suggest a product for exchange.

FIG. 11 is a flowchart of a method 1100 for recommending a product for exchange based on user perception. In box 1102, a user may request a gift exchange. The user may be a gift recipient who wishes to return and/or exchange the gift. The method may retrieve the user's perception map in box 1104. The perception map may reflect the user's perceptions of various products and may be built according to the method 300 shown in FIG. 3. The method may then provide a product recommendation based on the user's perception map (box 1108). In an embodiment, the recommendation may be provided on a graphical user interface. Recommendations may be presented one at a time, several at a time, or all at once on the graphical user interface. In box 1112, the method may determine whether a user selects a recommended item for exchange, for example based on input to the graphical user interface. If the user selects an item for exchange in box 1112, then the method may accept the exchange (box 1114). In an embodiment, if a user does not select an item for exchange, the method 1100 may proceed to “B” process the gift return, for example according to method 1200 shown in FIG. 12. In an alternative embodiment, prior to proceeding to “B,” the method may recommend other products. Steps 1108 and 1012 may be performed a pre-definable number of times or until a user indicates a desire to proceed to the gift return process “B”.

The product recommendation provided in box 1108 may be based on at least one of the following factors: a gift giver's designated budget, an inventory of a merchant, whether the user already owns the product, etc. For example, a merchant may prioritize sale of a particular product over another product. When two products are of the same or similar perceived value (i.e., within a threshold range) to a user, the method may select the product that the merchant prefers to sell. Merchant preferences may be specifiable, e.g., in a record of the product, based on profit margin, etc. The method may determine whether a user already owns a product based on browsing or purchase history, for example, data associated with a user profile.

In an alternative embodiment, in box 1112, the user may select more than one item. For example, the user may select a combination of items that total to equal to or less than the price paid for the gift. Method 1100 may be part of another method. For example, subsequent to step 1114, steps may be performed for realizing the exchange. A mailing label for the gift may be generated and an inventory may be updated to reflect the exchange. The selected items may be sent to the user to complete the exchange.

In another embodiment, prior to generating a product recommendation in box 1108, the method 1100 may notify a gift giver that a gift exchange has been requested. The method 1100 may request a spending amount (box 1106). The spending amount may be a threshold price such that the method 1100 generates recommendations of only those products that are below the spending amount in box 1108.

A perception map, for example developed according to method 300, may be used to make up a difference between perceived and retail values of a gift when the gift is returned. A gift giver may be provided an option at the time of purchase or time of return to define a return value. For example, the giver may provide additional funds such that a gift card may be of a value higher than it would be without the additional funds. This way, at the time of return, the recipient perceives that the giver originally spent more on the gift.

FIG. 12 is a flowchart of a method 1200 for increasing return value of a product based on user perception. The method may be triggered when it is determined that a user (“giver”) purchases a product (“gift”) in box 1202. In conjunction with the purchase or subsequent to the purchase, the method 1200 may determine a return value of the gift. The return value of the gift may thus be determined either in conjunction with the purchase of the gift (box 1202) or in conjunction with return of the gift (box 1208). In an embodiment, the return value of the gift may be a purchase price of the gift. In another embodiment, the return value of the gift may be a value specified by the giver. The value may be a monetary amount, a number of points, or any other measurable currency. The perceived value of a product may vary depending on the currency. In yet another embodiment, the method 1200 may provide suggested values from which the giver may select a return value of the gift. For example, the suggested values may be based on a perception map of the gift recipient. The perception map may be determined according to method 300. In box 1206, the method 1200 may determine that a recipient is returning a gift. The method 1200 may then output the return value of the gift in box 1212. For example, the output return value may be used to generate a gift card of the return value in exchange for return of the gift.

In an alternative embodiment, the method 1200 may begin when a recipient returns a gift (box 1206). When a recipient returns the gift, the method may notify the giver in box 1208. For example, the method may provide a SMS message, an email, a telephone call, a message within a web application, or the like to notify the giver that the recipient is returning the gift. In an embodiment, the return value of the gift may be a purchase price of the gift. In another embodiment, the return value of the gift may be a value specified by the giver. The value may be a monetary amount, a number of points, or any other measurable currency. The perceived value of a product may vary depending on the currency. In yet another embodiment, the method 1200 may provide suggested values from which the giver may select a return value of the gift. For example, the suggested values may be based on a perception map of the gift recipient. The perception map may be determined according to method 300. The method may then output the return value of the gift in box 1212. For example, the output return value may be used to generate a gift card of the return value in exchange for return of the gift.

The method 1200 may optionally perform “A” responsive to a determination that a recipient is returning a gift. For example, the method may perform a gift exchange such as method 1100 to provide an opportunity for exchanging the gift.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

The present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

For example, operation of the embodiments of the present invention has been described in the context of servers and terminals that embody marketplace and/or product placement systems. These systems can be embodied in electronic devices or integrated circuits, such as application specific integrated circuits, field programmable gate arrays and/or digital signal processors. Alternatively, they can be embodied in computer programs that execute on personal computers, notebook computers, tablet computers, smartphones or computer servers. Such computer programs typically are stored in physical storage media such as electronic-, magnetic- and/or optically-based storage devices, where they are read to a processor under control of an operating system and executed. And, of course, these components may be provided as hybrid systems that distribute functionality across dedicated hardware components and programmed general-purpose processors, as desired.

One or more embodiments of the disclosure may be referred to herein, individually and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A computer-implemented method for incorporating an image into template video, the method comprising:
determining a perceived value of a product, wherein the perceived value is a user's perception of the product represented by a product image and determination of the perceived value is based on a perception map that includes a relationship between prices associated with the product and qualities of the product;
determining a qualities threshold that includes a set of the prices and a set of the qualities below which the user is not expected to purchase the product; and
responsive to a determination that the perceived value is above the qualities threshold:
determining whether complexity of a form factor and a shape of the product exceeds a complexity threshold value that is associated with a stock element in template video data;
in response to the complexity exceeding the complexity threshold value, simplifying the product image from its true form factor such that the product image is modified to conform to the stock element in the template video data;
generating a frame of video data containing the simplified product image by incorporating the simplified product image into the template video data in place of the stock element of the template video data; and
rendering the generated frame of video data.

2. (canceled)

3. The method of claim 1, further comprising generating the perception map; the generating the perception map comprising:
generating a query regarding the perceived value of the product;
receiving a response to the query including the perceived value; and
storing the perceived value to the perception map.

4. The method of claim 1, further comprising updating the perceived value based on at least part of a browsing history of the user prior to storage of the perceived value.

5. The method of claim 3, wherein the generating of the query includes generating a query regarding respective perceived values of at least two products,
the method further comprising determining a relationship between the respective products.

6. The method of claim 5, further comprising displaying the product without branding, wherein the query regarding the perceived value of the product is generated without branding.

7. The method of claim 3, wherein the generating of the query includes:
displaying the product with native branding replaced with a second branding; and
generating a question for the perceived value of the product with the second branding.

8. The method of claim 1, wherein:
the template video data is encoded, and
the generating of the frame of video data containing the product image includes decoding the template video data and placing the product into the frame.

9. (canceled)

10. The method of claim 1, wherein the rendering includes: generating a multimedia stream, playing a multimedia stream, and distributing a multimedia stream.

11-20. (canceled)

21. The method of claim 1, wherein the price is plotted along a first axis in the perception map and the quality is plotted along a second axis in the perception map.

22. The method of claim 1, wherein the perception map includes a tiered format.

23-24. (canceled)

25. A system configured for incorporating an image into video data, the system comprising:
a storage device configured to store instructions; and
a processor coupled to the storage device and configured to execute the instructions to cause the system to perform operations, the operations comprising:
determine a perceived value of a product, wherein the perceived value is a user's perception of the product represented by a product image, and determination of the perceived value is based on a perception map that includes a relationship between prices associated with the product and qualities of the product;
determine a qualities threshold that includes a set of the prices and a set of the qualities below which the user is not expected to purchase the product; and
responsive to a determination that the perceived value is above the qualities threshold:
determine whether complexity of a form factor and a shape of the product exceeds a complexity threshold value that is associated with a stock element in template video data;
in response to the complexity exceeding the complexity threshold value, simplify the product image from its true form factor such that the product image is modified to conform to the stock element in the template video data;
generate a frame of video data containing the simplified product image by incorporating the simplified product image into the template video data in place of the stock element of the template video data; and
render the generated frame of video data.

26. (canceled)

27. The system of claim 25, wherein the operations further comprise:
generate a query regarding the perceived value of the product;
receive a response to the query including the perceived value; and
store the perceived value to the perception map.

28. The system of claim 27, wherein the operations further comprise update the perceived value based on at least part of a browsing history of the user prior to storage of the perceived value.

29. The system of claim 27, wherein the operations further comprise:
generate a query regarding respective perceived values of at least two products; and
determine a relationship between the respective products.

30. The system of claim 29, further comprising a display coupled to the processor, wherein the operations further comprise:
direct the display to present the product without branding,
wherein the query regarding the perceived value of the product is generated without branding.

31. The system of claim 27, further comprising a display coupled to the processor, wherein the operations further comprise:
direct the display to present the product with native branding replaced with a second branding; and
generate a question for the perceived value of the product with the second branding.

32. The system of claim 25, wherein:
the template video data is encoded, and
the generation of the frame of video data containing the product image includes decoding the template video data and placing the product into the frame.

33. The system of claim 25, wherein the operations further comprise:
determine whether complexity of the product is below the complexity threshold value; and
in response to the complexity of the product being below the complexity threshold value, generate video frame guidance that includes showing placement of a stock prop.
